(19) United States
(12) Patent Application Publication
(10) Pub. No.: US 2025/0247188 A1
(43) Pub. Date: Jul. 31, 2025

(54) DMRS Port Configuration for CP-OFDM

(71) Applicant: Apple Inc., CUPERTINO, CA (US)

(72) Inventors: Haitong SUN, Saratoga, CA (US); Chunxuan YE, San Diego, CA (US); Dawei ZHANG, Saratoga, CA (US); Hong HE, San Jose, CA (US); Oghenekome OTERI, San Diego, CA (US); Wei ZENG, Saratoga, CA (US); Yushu ZHANG, Beijing (CN)

(21) Appl. No.: 18/854,268

(22) PCT Filed: Apr. 12, 2022
(86) PCT No.: PCT/CN2022/086332

§ 371 Date: Oct. 4, 2024

(51) Int. Cl. H04L 5/00; H04L 27/26

(52) U.S. Cl. CPC H04L 5/0051; H04L 5/0016; H04L 27/2605

(57) ABSTRACT

A user equipment (UE) is configured to establish a connection to a fifth generation (5G) new radio (NR) network, wherein the connection is configured to utilize cyclic prefix (CP)-orthogonal frequency division multiplexing (OFDM) waveform and demodulation reference signal (DMRS) type 1, receive a DMRS port indication configured to indicate one or more DMRS ports assigned to the UE, wherein single symbol DMRS type 1 is configured to support up to eight DMRS ports and two symbol DMRS type 1 is configured to support up to sixteen DMRS ports and perform a transmission operation or a reception operation using the one or more DMRS ports assigned to the UE.

### TECHNICAL FIELD

The present disclosure generally relates to communication, and in particular, to the DMRS port configuration for CP-OFDM.

### BACKGROUND

A fifth generation (5G) new radio (NR) network may utilize cyclic prefix-orthogonal frequency division multiplexing (CP-OFDM) waveform for uplink and/or downlink communications. In 5G NR, under conventional circumstances, the network may support up to 8 or 12 demodulation reference signal (DMRS) ports for CP-OFDM depending on the DMRS configuration type, e.g., DMRS type 1 or DMRS type 2. It has been identified that there exists a need to increase the number of supported DMRS ports for CP-OFDM without increasing the DMRS overhead.

### SUMMARY

Some exemplary embodiments are related to a processor of a user equipment (UE) configured to establish a connection to a fifth generation (5G) new radio (NR) network, wherein the connection is configured to utilize cyclic prefix (CP)-orthogonal frequency division multiplexing (OFDM) waveform and demodulation reference signal (DMRS) type 1, receive a DMRS port indication configured to indicate one or more DMRS ports assigned to the UE, wherein single symbol DMRS type 1 is configured to support up to eight DMRS ports and two symbol DMRS type 1 is configured to support up to sixteen DMRS ports and perform a transmission operation or a reception operation using the one or more DMRS ports assigned to the UE.

Other exemplary embodiments are related to a processor of a base station configured to establish a connection to a user equipment (UE), wherein the connection is configured to utilize cyclic prefix (CP)-orthogonal frequency division multiplexing (OFDM) waveform and demodulation reference signal (DMRS) type 1, transmit a DMRS port indication configured to indicate one or more DMRS ports assigned to the UE, wherein single symbol DMRS type 1 is configured to support up to eight DMRS ports and two symbol DMRS type 1 is configured to support up to sixteen DMRS ports and perform a transmission operation or a reception operation using the one or more DMRS ports assigned to the UE.

Still further exemplary embodiments are related to a processor of a user equipment (UE) configured to establish a connection to a fifth generation (5G) new radio (NR) network, wherein the connection is configured to utilize cyclic prefix (CP)-orthogonal frequency division multiplexing (OFDM) waveform and demodulation reference signal (DMRS) type 2, receive a DMRS port indication configured to indicate one or more DMRS ports assigned to the UE, wherein single symbol DMRS type 2 is configured to support up to twelve DMRS ports and two symbol DMRS type 2 is configured to support up to twenty four DMRS ports and perform a transmission operation or a reception operation using the one or more DMRS ports assigned to the UE.

Additional exemplary embodiments are related to a processor of a base station configured to establish a connection to a user equipment (UE), wherein the connection is configured to utilize cyclic prefix (CP)-orthogonal frequency division multiplexing (OFDM) waveform and demodulation reference signal (DMRS) type 2, transmit a DMRS port indication configured to indicate one or more DMRS ports assigned to the UE, wherein single symbol DMRS type 2 is configured to support up to twelve DMRS ports and two symbol DMRS type 2 is configured to support up to twenty four DMRS ports and perform a transmission operation or a reception operation using the one or more DMRS ports assigned to the UE.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIGS. 4a-4d show examples of code division multiplex (CDM) groups for different demodulation reference signal (DMRS) configuration types and different DMRS symbol durations.

FIG. 5 shows an example of two symbol DMRS type 2 occupying multiple physical resource blocks (PRBs) according to various exemplary embodiments.

FIGS. 6a-6c show various examples related to the frequency domain DMRS subsampling techniques introduced herein according to various exemplary embodiments.

FIGS. 7a-7d show various examples related to the frequency domain DMRS subsampling techniques introduced herein according to various exemplary embodiments.

FIGS. 8a-8d show various examples related to the time domain DMRS subsampling techniques introduced herein according to various exemplary embodiments.

FIG. 9 shows a signaling diagram for providing the UE with a DMRS port indication for cyclic prefix-orthogonal frequency division multiplexing (CP-OFDM) according to various exemplary embodiments.

FIGS. 10a-10b show examples of different DMRS port configurations according to various exemplary embodiments.

### DETAILED DESCRIPTION

The exemplary embodiments may be further understood with reference to the following description and the related appended drawings, wherein like elements are provided with the same reference numerals. The exemplary embodiments relate to demodulation reference signal (DMRS) ports for cyclic prefix-orthogonal frequency division multiplexing (CP-OFDM) waveform.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with regard to a fifth generation (5G) New Radio (NR) network. However, reference to a 5G NR network is merely provided for illustrative purposes. The exemplary embodiments may be utilized with any network that utilizes CP-OFDM waveform in the uplink and/or downlink.

In the various examples described herein, reference is made to 5G NR physical resources arranged in a resource grid comprising subcarriers in the frequency domain and OFDM symbols in the time domain. Each element in a resource grid may be referred to as a resource element (RE) and each RE may have a location within in the resource grid that may be uniquely identified by coordinates (k, l) where (k) represents a subcarrier location and (l) represents a symbol location.

A resource block (RB) may refer to 12 consecutive subcarriers in the frequency domain. RBs may be further characterized as common resource blocks (CRBs) or physical resource blocks (PRBs). CRBS may be indexed from 0 and upwards in the frequency domain for a particular subcarrier spacing (SCS) and PRBs may be defined within a bandwidth part (BWP) for a particular SCS. There is a defined relationship between CRBS and PRBs such that the location of a BWP and its PRBs may be determined relative to CRB index 0.

The exemplary embodiments are described with regard to DMRS for CP-OFDM waveform. Those skilled in the art will understand that DMRS is a reference signal that may be used for channel estimation. CP-OFDM may utilize DMRS to enable multiple layer transmissions where each layer corresponds to a different antenna port, e.g., DRMS port. Under conventional circumstances, DMRS type 1 may support up to four DMRS ports for single symbol DMRS and up to eight DMRS ports for two symbol DMRS. DMRS type 2 may support up to six DMRS ports for single symbol DMRS and up to twelve DMRS ports for two symbol DMRS. The exemplary embodiments described herein introduce techniques for increasing the number of supported DMRS ports for CP-OFDM.

According to some aspects, the exemplary embodiments introduce frequency domain DMRS subsampling techniques configured to support a larger number of DMRS ports for CP-OFDM without increasing the DMRS overhead. According to other aspects, the exemplary embodiments introduce time domain DMRS subsampling techniques configured to support a larger number of DMRS ports for CP-OFDM without increasing the DMRS overhead. In addition, the exemplary embodiments introduce signaling mechanisms to enable the frequency domain DMRS subsampling techniques and/or the time domain DMRS subsampling techniques described herein. The exemplary embodiments may be utilized independently from one another, in conjunction with other currently implemented DMRS mechanisms for CP-OFDM, in conjunction with future implementations of DMRS mechanisms for CP-OFDM or independently from other DMRS mechanisms for CP-OFDM.

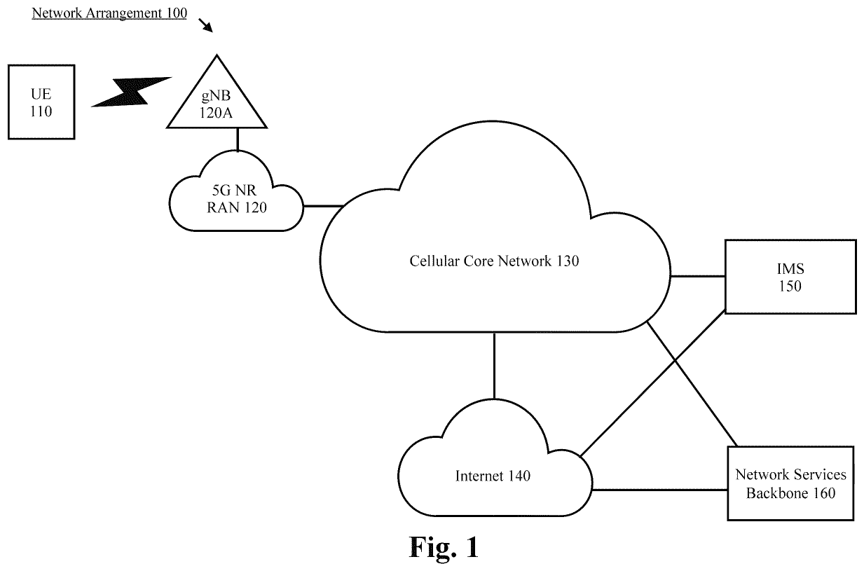

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

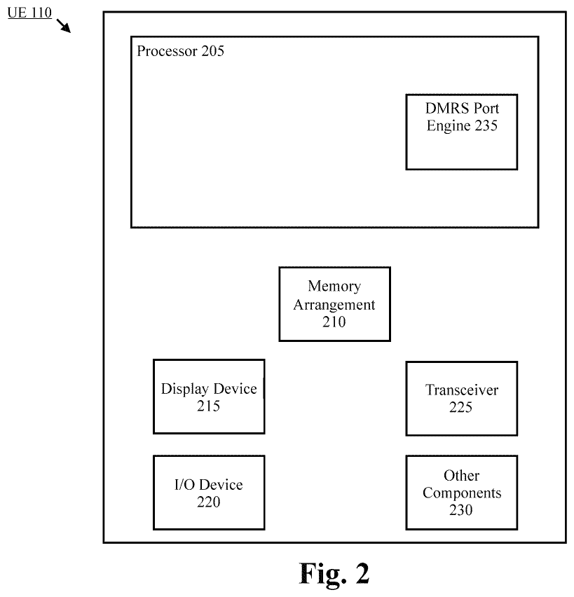

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a DMRS port engine 235. The DMRS port engine 235 may perform various operations related to DMRS for CP-OFDM. The operations may include, but not are limited to, receiving configuration information for DMRS, receiving an indication identifying which DMRS ports are allocated to the REs assigned to the UE 110, receiving the DMRS using the configured DMRS port and transmitting DMRS using the configured DMRS port.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

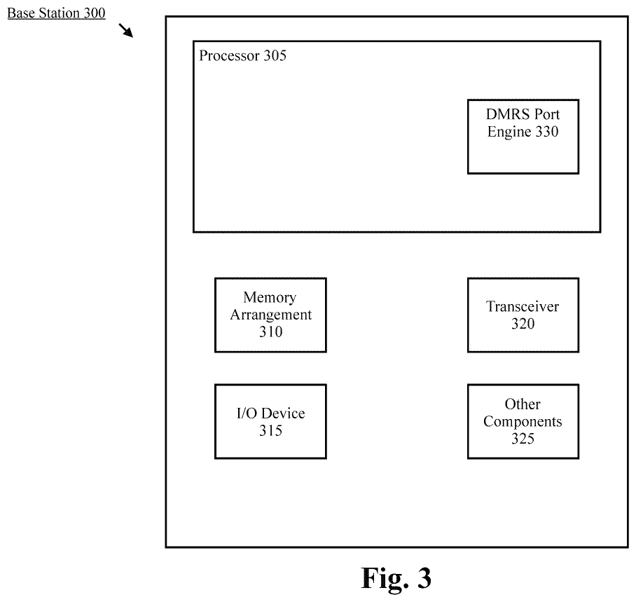

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the base station 300. For example, the engines may include a DMRS port engine 330. The DMRS port engine 330 may perform various operations related to DMRS for CP-OFDM. The operations may include, but are not limited to, transmitting DMRS configuration information to one or more UEs, allocating DMRS ports to one or more UEs (e.g., single user-multiple input multiple output (SU-MIMO), multi-user MIMO (MU-MIMO), etc.), transmitting an indication to each UE identifying which DMRS ports have been allocated to REs assigned to the UE, transmitting DMRS to one or more UEs and receiving DMRS from one or more UEs.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

As mentioned above, the exemplary embodiments are described with regard to DMRS type 1 and DMRS type 2. For both DMRS type 1 and DMRS type 2, multiple DMRS ports may be mapped to the same REs. For example, an orthogonal cover code (OCC) of length 2 may be used in the frequency domain to enable two DMRS ports to utilize the same REs. When two symbol DMRS is utilized, the number of DMRS ports that may be mapped to the same REs may be further increased by using OCC of length 2 in the time domain. Throughout this description, multiple DMRS ports that are configured to use the same REs but are separated in the code domain may be referred to as a “code division multiplex (CDM) group.” To differentiate between different CDM groups, the exemplary embodiments may refer to CDM group 0, CDM group 1, CDM group 2, etc. Similarly, to differentiate between DMRS ports, the exemplary embodiments may refer to port 1, port 2, port 3, port 4, etc. However, the manner in which CDM groups and DMRS ports are numbered throughout this description is merely provided for illustrative purposes and is not intended to limit the exemplary embodiments in any way.

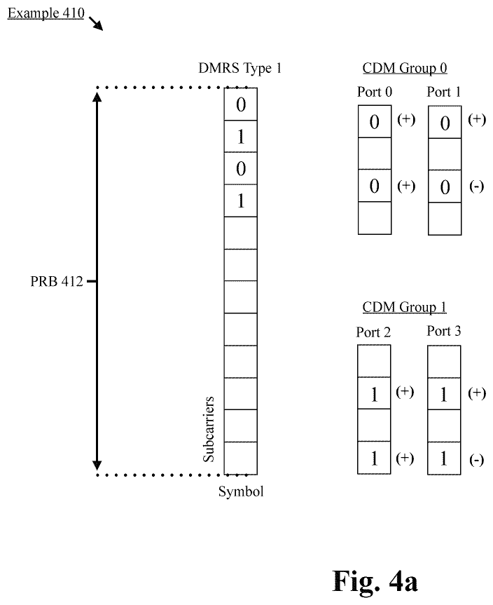

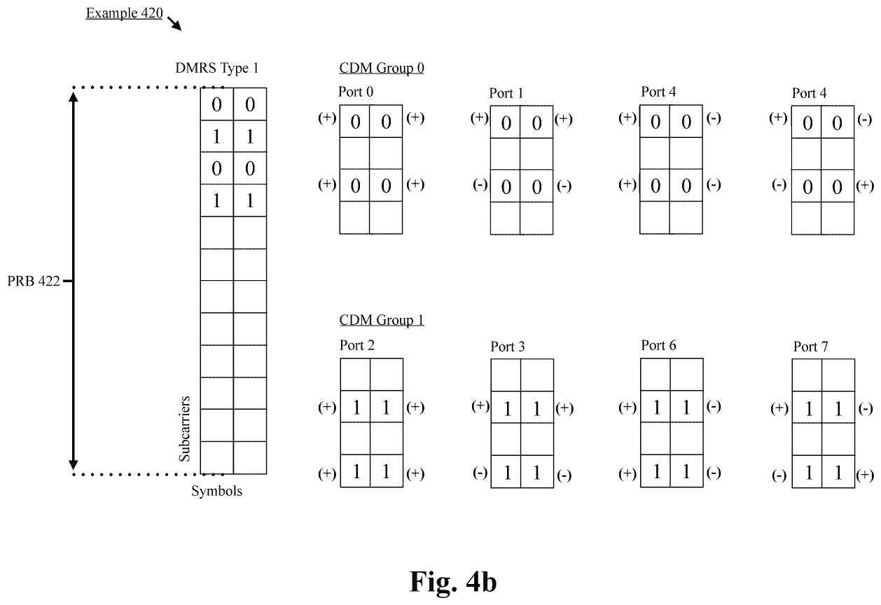

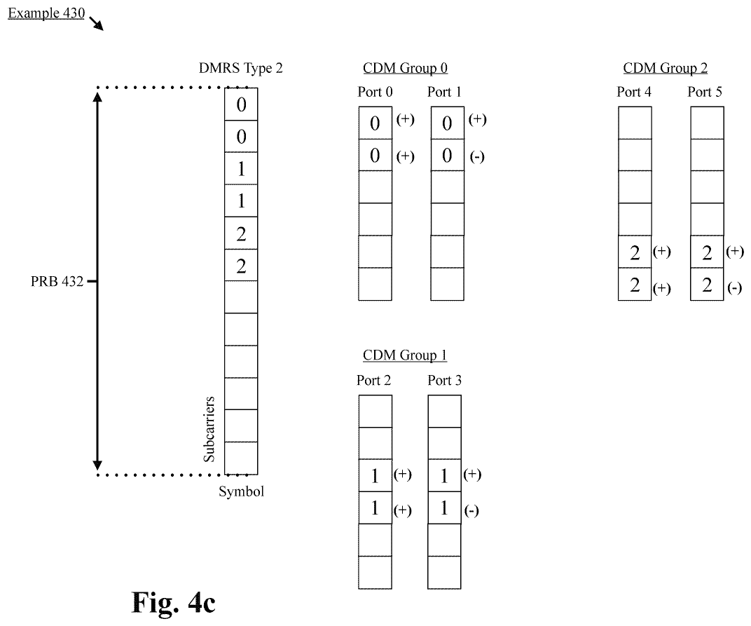

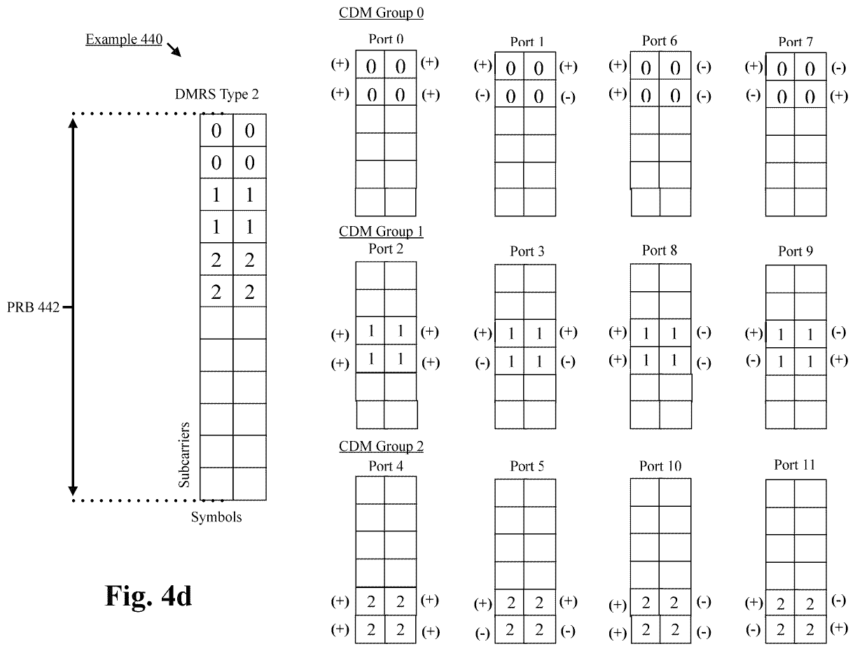

FIG. 4a shows an example 410 of DMRS type 1 CDM groups for single symbol DMRS arranged within a PRB according to various exemplary embodiments. Example 410 includes a PRB 412 comprising 12 subcarriers in the frequency domain and a single symbol in the time domain.

Example 410 includes CDM group 0 and CDM group 1. In FIG. 4a, to demonstrate the mapping of the different CDM groups to REs, the REs mapped to CDM group 0 are marked with a “0” and the REs mapped to CDM group 1 are marked with a “1”. For DMRS type 1, each CDM group may be mapped to two REs within the symbol that are separated from one another by a single subcarrier in the frequency domain. CDM group 0 and CDM group 1 may be interlaced and occupy every other subcarrier within a span of four consecutive subcarriers. For example, CDM group 0 may occupy the even numbered subcarriers (e.g., 0, 2) and CDM group 1 may occupy the odd numbered subcarriers (e.g., 1, 3) (or vice versa). Although not shown in the example 410, in some configurations, the CDM group 0 and CDM group 1 pattern may repeat in the frequency domain using the next entries in the DMRS sequence.

For DMRS type 1, single symbol DMRS may support two DMRS ports per CDM group. Example 410 illustrates that two DMRS ports (e.g., port 0, port 1) may belong to CDM group 0 for single symbol DMRS. The DMRS ports of CDM group 0 may utilize the same REs but are separated in the code domain using the OCC of length 2 in the frequency domain. Similarly, example 410 illustrates that two DMRS ports (e.g., port 2, port 3) may belong to CDM group 1. The DMRS ports of CDM 1 group may utilize the same REs but are separated from one another in the code domain using the OCC of length 2 in the frequency domain. An example of the different orthogonal sequences are illustrated in FIG. 4a using the (+) and (−) symbols.

FIG. 4b shows an example 420 of DMRS type 1 CDM groups for two symbol DMRS arranged within a PRB according to various exemplary embodiments. Example 420 includes a PRB 422 comprising 12 subcarriers in the frequency domain and two symbols in the time domain.

Example 420 includes CDM group 0 and CDM group 1. In FIG. 4b, to demonstrate the mapping of the different CDM groups to REs, the REs mapped to CDM group 0 are marked with a “0” and the REs mapped to CDM group 1 are marked with a “1”. For DMRS type 1, each CDM group may be mapped to a total of four REs. A first set of two adjacent REs in the time domain are separated from a second set of two adjacent REs in the time domain by a single subcarrier in the frequency domain. CDM group 0 and CDM group 1 may be interlaced and occupy every other subcarrier within a span of four consecutive subcarriers. For example, CDM group 0 may occupy the even numbered subcarriers (e.g., 0, 2) and CDM group 1 may occupy the odd numbered subcarriers (e.g., 1, 3) or vice versa. Although not shown in the example 420, in some configurations, the pattern of CDM group 0 and CDM group 1 may repeat in the frequency domain using the next entries in the DMRS sequence.

For DMRS type 1, two symbol DMRS may support four DMRS ports per CDM group. Example 420 illustrates that four DMRS ports (e.g., port 0, port 1, port 4, port 5) may belong to CDM group 0 for two symbol DMRS. The DMRS ports of CDM group 0 may utilize the same REs but are separated in the code domain using an OCC of 2 in the frequency domain and an OCC of length 2 in the time domain. Similarly, example 420 illustrates that four DMRS ports (e.g., port 2, port 3, port 6, port 7) belong to CDM group 1. The DMRS ports of a CDM group 1 may utilize the same REs but are separated from one another in the code domain using an OCC of 2 in the frequency domain and an OCC of length 2 in the time domain. An example of the different orthogonal sequences are illustrated in FIG. 4b using the (+) and (−) symbols.

DMRS type 2 may utilize three CDM groups. For single symbol DMRS, each DMRS type 2 CDM group may support two DMRS ports. For two symbol DMRS, each DMRS type 2 CMD group may support four DMRS ports. Thus, compared to DMRS type 1, DMRS type 2 may support a larger number of DMRS ports but have a lower DRMS density per DMRS port.

FIG. 4c shows an example 430 of DMRS type 2 CDM groups for single symbol DMRS arranged within a PRB according to various exemplary embodiments. Example 430 includes a PRB 432 comprising 12 subcarriers in the frequency domain and a single symbol in the time domain.

Example 430 includes CDM group 0, CDM group 1 and CDM group 2. In FIG. 4c, to demonstrate the mapping of the different CDM groups to REs, the REs mapped to CDM group 0 are marked with a “0,” the REs mapped to CDM group 1 are marked with a “1” and the REs mapped to CDM group 2 are marked with a “2.” For DMRS type 2, each CDM group may be mapped to a total of two REs. CDM group 0 may be mapped to two adjacent REs in the frequency domain, CDM group 1 may be mapped to two adjacent REs in the frequency domain and CDM group 2 may also mapped to two adjacent REs in the frequency domain. CDM groups 0-2 are arranged to occupy six consecutive subcarriers. Although not shown in the example 430, in some configurations, CDM group 0, CDM group 1 and CDM group 2 may repeat in the frequency domain using the next entries of the DMRS sequence.

For DMRS type 2, single symbol DMRS may support two DMRS ports per CDM group. Example 430 illustrates that two DMRS ports (e.g., port 0, port 1) may belong to CDM group 0 for single symbol DMRS. The DMRS ports of CDM group 0 may utilize the same REs but are separated in the code domain using an OCC of length 2 in the frequency domain. The example 430 also illustrates that two DMRS ports (e.g., port 2, port 3) may belong to CDM group 1. The DMRS ports of CDM 1 group may utilize the same REs but are separated from one another in the code domain using an OCC of length 2 in the frequency domain. The example 430 also illustrates that two DMRS ports (e.g., port 4, port 5) may belong to CDM group 2. The DMRS ports of CDM 2 group may utilize the same REs but are separated from one another in the code domain using an OCC of length 2 in the frequency domain. An example of the different orthogonal sequences are illustrated in FIG. 4c using the (+) and (−) symbols.

FIG. 4d shows an example 440 of DMRS type 2 CDM groups for two symbol DMRS arranged within a PRB according to various exemplary embodiments. Example 440 includes a PRB 442 comprising 12 subcarriers in the frequency domain and two symbols in the time domain.

Example 440 includes CDM group 0, CDM group 1 and CDM group 2. In FIG. 4d, to demonstrate the mapping of the different CDM groups to REs, the REs mapped to CDM group 0 are marked with a “0,” the REs mapped to CDM group 1 are marked with a “1” and the REs mapped to CDM group 2 are marked with a “2.” For DMRS type 2, each CDM group may be mapped to a total of four REs. CDM group 0 may be mapped to a two adjacent REs in the frequency domain per DMRS symbol, CDM group 1 may be mapped to two adjacent REs in the frequency domain per DMRS symbol and CDM group 2 may also mapped to two adjacent REs in the frequency domain per DMRS symbol. CDM groups 0-2 are arranged to occupy six consecutive subcarriers. Although not shown in the example 440, in some configurations, the pattern of CDM group 0, CDM group 1 and CDM group 2 may repeat in the frequency domain using the next entries of the DMRS sequence.

For DMRS type 2, single symbol DMRS may support four DMRS ports per CDM group. Example 440 illustrates that four DMRS ports (e.g., port 0, port 1, port 6, port 7) may belong to CDM group 0 for two symbol DMRS. The DMRS ports of CDM group 0 may utilize the same REs but are separated in the code domain using an OCC of 2 in the frequency domain and an OCC of length 2 in the time domain. Similarly, example 440 illustrates that four DMRS ports (e.g., port 2, port 3, port 8, port 9) may belong to CDM group 1. The DMRS ports of a CDM group 1 may utilize the same REs but are separated from one another in the code domain using an OCC of 2 in the frequency domain and an OCC of 2 in the time domain. Example 440 also illustrates that four DMRS ports (e.g., port 4, port 5, port 10, port 11) may belong to CDM group 2. The DMRS ports of CDM group 2 may utilize the same REs but are separated from one another in the code domain using an OCC of 2 in the frequency domain and an OCC of 2 in the time domain. An example of the different orthogonal sequences are illustrated in FIG. 4d using the (+) and (−) symbols.

For DMRS type 1 and DMRS type 2, multiple PRBs may occupy the same one or more symbols and be indexed 0 to (N) in the frequency domain. In some configurations, each of the PRBs indexed 0-N may contain REs mapped to the same CDM groups.

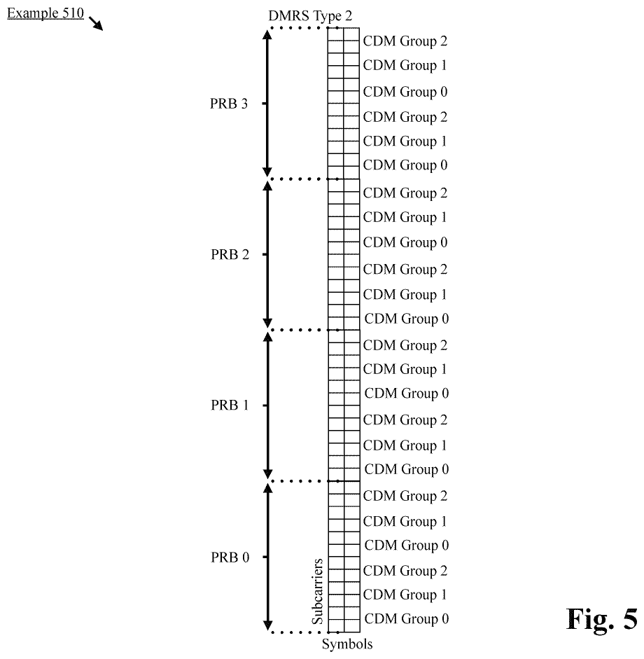

FIG. 5 shows an example 510 of two symbol DMRS type 2 occupying multiple PRBs according to various exemplary embodiments. Initially, consider a scenario in which two symbol DMRS type 2 occupies PRBs indexed 0-3. Each PRB is mapped to the same CDM groups (e.g., CDM group 0, CDM group 1 and CDM group 2) and each CDM group includes four DMRS ports. In the example 510, the CDM groups are repeated in the frequency domain from PRB 0 to PRB 3. Therefore, in example 510, each DMRS port is mapped to eight REs per PRB and 32 total REs across PRBs 0-3 (8 RES*4 PRBs). While this example references two symbol DMRS type 2, those skilled in the art will understand that similar configurations may be used for any number of PRBs and any combination of DMRS type (e.g., DMRS type 1, DMRS type 2) and symbol duration (e.g., one symbol DMRS, two symbol DMRS, etc.).

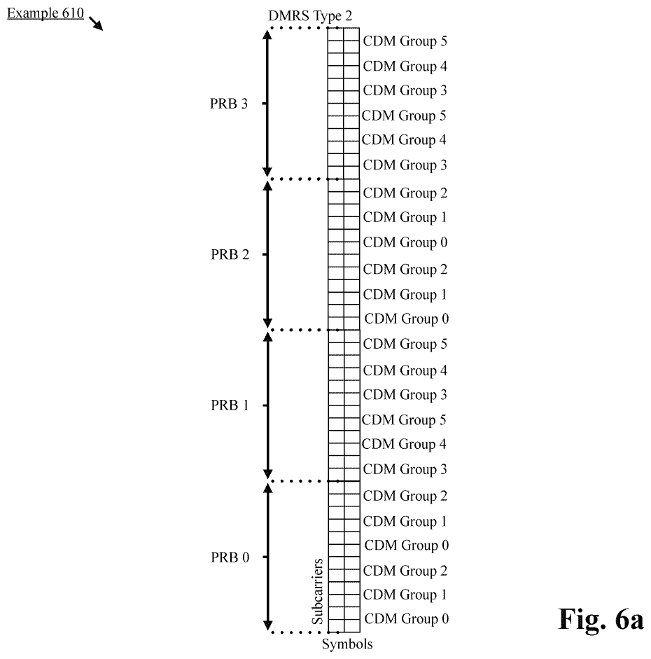

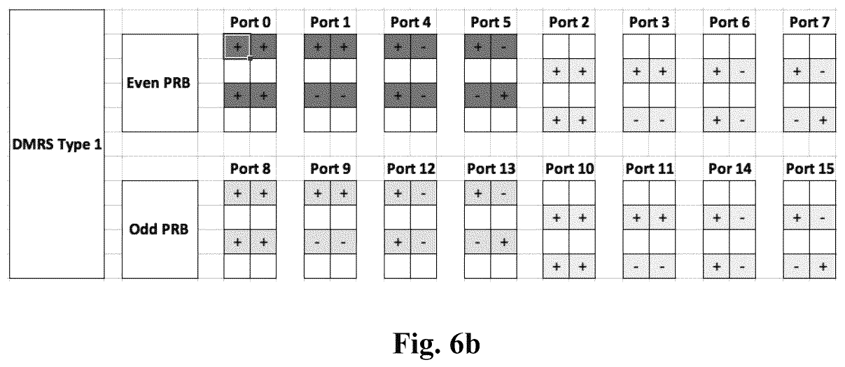

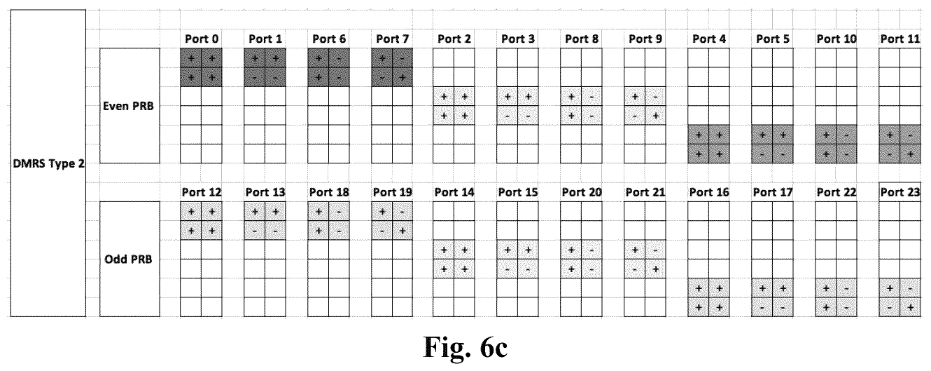

For CP-OFDM, the number of supported DMRS ports may be increased by reducing the frequency domain DMRS density per DMRS port. In some embodiments, the frequency domain DMRS density per DMRS port may be reduced based on PRB splitting where a first set of one or more PRBs are assigned to a first set of one or more CDM groups and second set of one or more different PRBs within the same one or more symbols are assigned to a second different set of one or more CDM groups. For instance, consider example 510 where each PRB indexed 0-3 contain REs mapped to the CDM groups 0-2. The frequency domain DMRS density per DMRS port may be reduced by 50 percent by utilizing half of the PRBs for CDM groups 0-2 and the other half of the PRBs for different CDM groups, e.g., CDM groups 3, CDM group 4 and CDM group 5. In this example, like in example 510, each of the CDM groups 0-5 may support four DMRS ports. Thus, compared to example 510, the number of supported DMRS ports may be increased from 12 to 24 but each DMRS port does not appear as often in the frequency domain. An example of this type of arrangement is shown below with regard to FIG. 6a.

As mentioned above, for DMRS type 1 and DMRS type 2, multiple PRBs may occupy the same one or more symbols and be indexed 0-N in the frequency domain. To increase the number of supported DMRS ports, the PRBs of the DMRS may be split between different CDM groups. FIGS. 6a-6c provide various examples related to the frequency domain DMRS subsampling techniques introduced herein.

FIG. 6a shows an example 610 of two symbol DMRS type 2 occupying multiple PRBs according to various exemplary embodiments. Initially, consider a scenario in which two symbol DMRS type 2 occupies PRBs indexed 0-3. In this example, to increase the number of supported DMRS ports, even indexed PRBs are mapped to a first set of one or more CDMs groups (e.g., CDM group 0, CDM group 1 and CDM group 2) and odd indexed PRBs are mapped to a different set of one or more CDM groups (e.g., CDM group 3, CDM group 4 and CDM group 5). Each CDM group may include up to four DMRS ports for a total of 24 DMRS ports.

In example 610, each set of CDM groups are repeated in the frequency domain within their respective assigned PRBS but different sets of CDM groups are mapped to adjacent PRBs. Thus, PRB 0 includes a pattern of REs mapped to CDM groups 0-2, PRB 1 includes a pattern of REs mapped to CDM groups 3-5, PRB 2 includes a pattern of REs mapped to CDM groups 0-2 and PRB 3 includes a pattern of REs mapped to CDM groups 3-5. In example 610, each DMRS port is mapped to eight REs every other PRB for a total 16 REs across the four PRBs compared to the 32 REs occupied per DMRS port across the four PRBs in example 510 of FIG. 5. As shown in example 610, reducing the frequency density per DMRS port allows more DMRS ports to be supported for CP-OFDM waveform.

Example 610 references two symbol DMRS type 2, those skilled in the art will understand that similar configurations may be used for any number of PRBs and any combination of DMRS type (e.g., DMRS type 1, DMRS type 2) and symbol duration (e.g., one symbol DMRS, two symbol DMRS, etc.) to increase the number of supported DMRS ports. To provide some examples, for single symbol DMRS configuration type 1, even indexed PRBs may be used to support two CDM groups each with two DMRS ports for a total of four DMRS ports and odd indexed PRBs may be used to support a different set of two CDM groups each with two DMRS ports for a total of four DMRS ports. Thus, for single symbol DMRS configuration type 1, when the frequency density per DMRS port is reduced based on PRBs, the number of supported DMRS ports may equal eight DMRS ports. For two symbol DMRS configuration type 1, even indexed PRBs may be used to support two CDM groups each with four DMRS ports for a total of eight DMRS ports and odd indexed PRBs may be used to support a different set of two CDM groups each with four DMRS ports for a total of eight DMRS ports. Thus, for two symbol DMRS configuration type 1, when the frequency density per DMRS port is reduced based on PRBs, the number of supported DMRS ports may be 16 DMRS ports. For single symbol DMRS configuration type 2, even indexed PRBs may be used to support three CDM groups each with two DMRS ports for a total of six DMRS ports and odd indexed PRBs may be used to support a different set of three CDM groups each two DMRS ports for a total of six DMRS ports. Thus, for single symbol DMRS configuration type 2, when the frequency density per DMRS port is reduced based on PRBs, the number of supported DMRS ports may be 12 DMRS ports. The example 610 shows that for two symbol DMRS configuration type 2, when the frequency density per DMRS ports is reduced based on PRB splitting, the number of supported DMRS ports may be 24 DMRS ports where 12 DMRS ports are mapped to even indexed PRBs and 12 different DMRS ports are mapped to odd indexed PRBS.

FIG. 6b illustrates the number of DMRS ports that may be supported by two symbol DMRS type 1 for CP-OFDM according to various exemplary embodiments. In this example, the frequency domain density per DMRS port is reduced by 50 percent based on PRB splitting. Even indexed PRBs are assigned to CDM group 0 comprising port 0, port 1, port 3 and port 5 and CDM group 1 comprising port 2, port 3, port 6 and port 7. Examples of the different orthogonal sequences that may be applied using OCC in the frequency and time domain are illustrated in FIG. 5b using the (+) and (−) symbols.

FIG. 6c illustrates the number of DMRS ports that may be supported by two symbol DMRS type 2 for CP-OFDM according to various exemplary embodiments. In this example, the frequency domain density per DMRS port is reduced by 50 percent based on PRB splitting. Even indexed PRBs are assigned to CDM group 0 comprising port 0, port 1, port 6 and port 7, CDM group 1 comprising port 2, port 3, port 8 and port 9 and CDM group 2 comprising port 4, port 5, port 10 and port 11. Odd indexed PRBs are assigned to CDM group 3 comprising port 12, port 13, port 18 and port 19, CDM group 4 comprising port 14, port 15, port 20 and port 21 and CDM group 5 comprising port 16, port 17, port 22 and port 23. Examples of the different orthogonal sequences that may be applied using OCC in the frequency and time domain are illustrated in FIG. 6c using the (+) and (−) symbols.

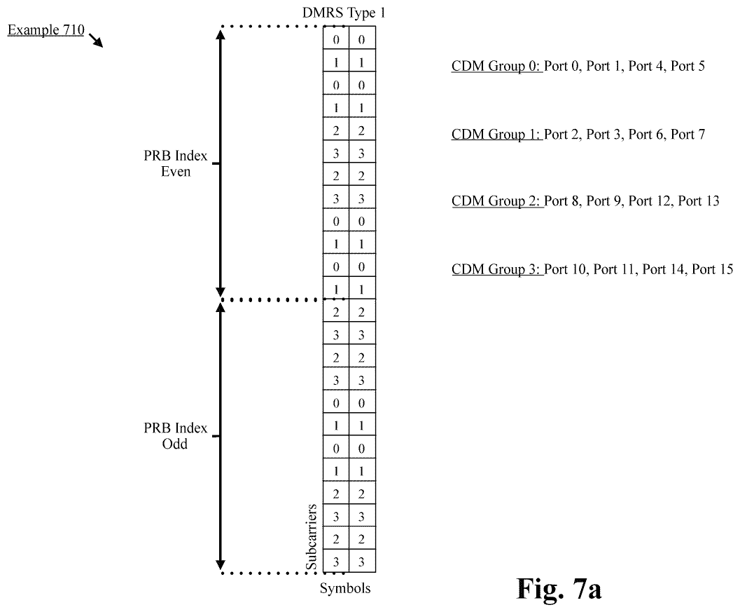

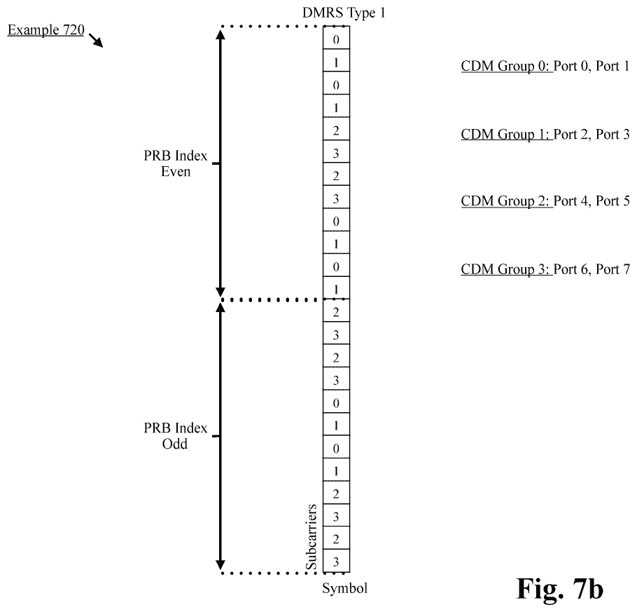

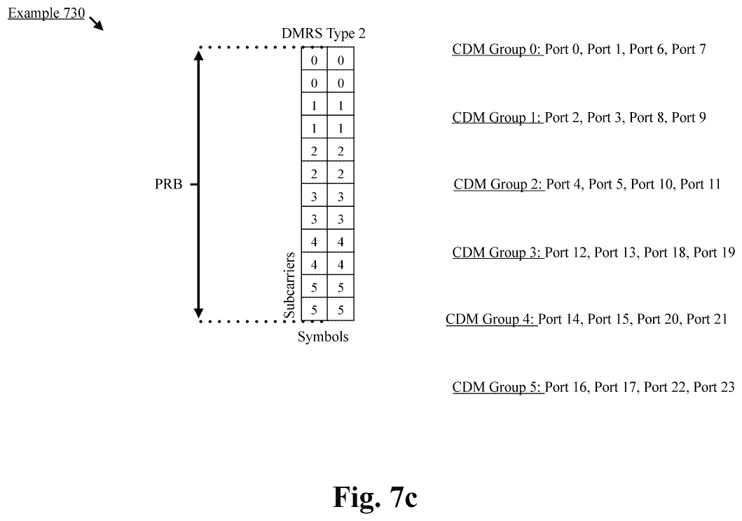

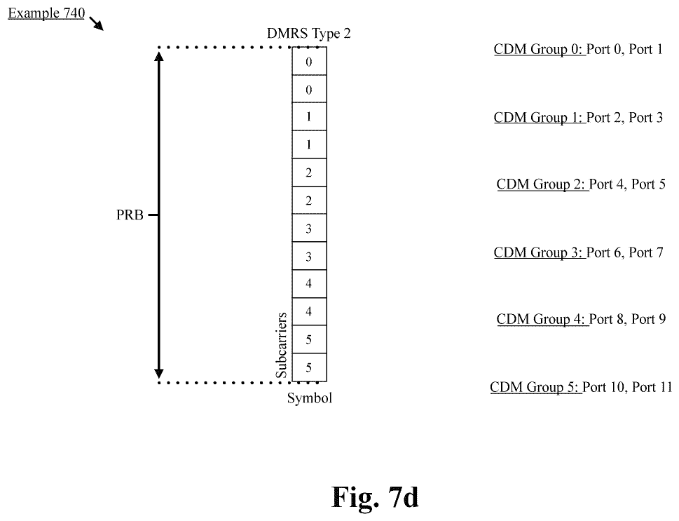

In other embodiments, the frequency domain DMRS density per DMRS port may be reduced by reducing the number of REs allocated to each CDM group. This allows for more DMRS ports to be supported for CP-OFDM. FIGS. 7a-7d show various examples related to frequency domain density reduction per DMRS port based on CDM groups.

As will be described in more detail below, for DMRS configuration type 1, each PRB may include REs mapped to four CDM groups. However, in some configurations, every other PRB may have a different CDM group pattern. When frequency domain density of DMRS per DMRs port is reduced by 50 percent based on CDM groups, single symbol DMRS configuration type 1 may support up to eight DMRS ports. When frequency domain density of DMRS per DMRs port is reduced by 50 percent based on CDM groups, two symbol DMRS configuration type 1 may support up to 16 DMRS ports.

FIG. 7a shows an example 710 of two symbol DRMS type 1 configured to support up to 16 DMRS ports according to various exemplary embodiments. In example 710, DMRS type 1 may support up to four CDM groups, e.g., CDM group 0, CDM group 1, CDM group 2 and CDM group 3. Each CDM group may support up to four DMRS ports. In the example 710, CDM port 0 may include port 0, port 1, port, 4 and port 5, CDM port 1 may include port 2, port 3, port 6 and port 7, CDM group 2 may include port 8, port 9, port 12 and port 13 and CMD group 3 may support port 10, port 11, port 14 and port 15.

As mentioned above, the CDM pattern may be different every other PRB. For instance, each PRB may include twelve REs and four REs may be used per each instance of a CDM group. In a first PRB a CDM group may be assigned eight REs and in an adjacent PRB, the same CDM group may be assigned four REs. This may be applied to all four CDM groups to create two different CDM group patterns that may be used within a PRB. In example 710, even indexed PRBs utilizes a first pattern of CDM groups and odd indexed PRBS utilize a second different pattern of CDM groups. To demonstrate the mapping of the different CDM groups to REs, the REs mapped to CDM group 0 are marked with a “0,” the REs mapped to CDM group 1 are marked with a “1,” the REs mapped to CDM group 2 are marked with a “2” and the REs mapped to CDM group 3 are marked with a “3”. In even indexed PRBs, eight REs may be mapped to CDM group 0, eight REs may be mapped to CDM group 1, four REs may be mapped to CDM group 2 and four REs may be mapped to CDM group 3. In odd indexed PRBs, the CDM group pattern is different where four REs may be mapped to CDM group 0, four REs may be mapped to CDM group 1, eight REs may be mapped to CDM group 2 and eight REs may be mapped to CDM group 3. This pattern provides an equal DMRS density per DMRS port every two PRBs.

FIG. 7b shows an example 720 of single symbol DRMS type 1 configured to support up to eight DMRS ports according to various exemplary embodiments. In example 720, DMRS type 1 may support up to four CDM groups, e.g., CDM group 0, CDM group 1, CDM group 2 and CDM group 3. Each CDM group may support up to two DMRS ports. In the example 710, CDM port 0 may include port 0 and port 1, CDM port 1 may include port 2 and port 3, CDM group 2 may include port 4 and port 5 and CMD group 3 may support port 6 and port 7.

Like two symbol DMRS type 1, the CDM pattern may be different every other PRB for single symbol DMRS type 1. For instance, each PRB may include twelve REs and two REs may be used per each instance of a CDM group. In a first PRB a CDM group may be assigned four REs and in an adjacent PRB, the same CDM group may be assigned two REs. This may be applied to all four CDM groups to create two different CDM group patterns that may be used within a PRB. In example 720, even indexed PRBs utilizes a first pattern of CDM groups and odd indexed PRBS utilize a second different pattern of CDM groups. To demonstrate the mapping of the different CDM groups to REs, the REs mapped to CDM group 0 are marked with a “0,” the REs mapped to CDM group 1 are marked with a “1,” the REs mapped to CDM group 2 are marked with a “2” and the REs mapped to CDM group 3 are marked with a “3.” In even indexed PRBs, four REs may be mapped to CDM group 0, four REs may be mapped to CDM group 1, two REs may be mapped to CDM group 2 and two REs may be mapped to CDM group 3. In odd indexed PRBs, the CDM group pattern is different where two REs may be mapped to CDM group 0, two REs may be mapped to CDM group 1, four REs may be mapped to CDM group 2 and four RES may be mapped to CDM group 3. This pattern provides an equal DMRS density per DMRS port every two PRBS.

In various examples provided above, reference is made to even indexed PRBs and odd indexed PRBs, e.g., FIGS. 6a-6d and 7a-7b. Throughout this description, determining even indexed PRBs and odd indexed PRBs may be based on common resource block 0 or based on the PDSCH frequency domain resource allocation (FDRA).

For DMRS configuration type 2, each PRB may include REs mapped to six CDM groups. When frequency domain density of DMRS per DMRs port is reduced by 50 percent based on CDM groups, single symbol DMRS configuration type 1 may support up to twelve DMRS ports. When frequency domain density of DMRS per DMRs port is reduced by 50 percent based on CDM groups, two symbol DMRS configuration type 2 may support up to 24 DMRS ports.

FIG. 7c shows an example 730 of two symbol DRMS type 2 configured to support up to 24 DMRS ports according to various exemplary embodiments. In example 730, DMRS type 2 may support up to six CDM groups, e.g., CDM group 0, CDM group 1, CDM group 2, CDM group 3, CDM group 4 and CDM group 5. Each CDM group may be mapped to four REs per PRB and may support up to four DMRS ports. In the example 730, CDM port 0 may include port 0, port 1, port, 6 and port 7, CDM port 1 may include port 2, port 3, port 8 and port 9, CDM group 2 may include port 4, port 5, port 10 and port 11, CMD group 3 may support port 12, port 13, port 18 and port 19, CDM group 4 may include port 14, port 15, port 20 and port 21 and CDM group 5 may include port 16, port 17, port 22 and port 23.

For DMRS type 2, each PRB may have the same CDM pattern. In example 730, to demonstrate the mapping of the different CDM groups to REs, the REs mapped to CDM group 0 are marked with a “0,” the REs mapped to CDM group 1 are marked with a “1,” the REs mapped to CDM group 2 are marked with a “2,” the REs mapped to CDM group 3 are marked with a “3,” the REs mapped to CDM group 4 are marked with a “4” and the REs mapped to CDM group 5 are marked with a “5.” This pattern provides an equal DMRS density per DMRS port in every PRB.

FIG. 7d shows an example 740 of single symbol DRMS type 2 configured to support up to twelve DMRS ports according to various exemplary embodiments. In example 740, DMRS type 2 may support up to six CDM groups, e.g., CDM group 0, CDM group 1, CDM group 2, CDM group 3, CDM group 4 and CDM group 5. Each CDM group may be mapped to two REs per PRB and may support up to two DMRS ports. In the example 740, CDM port 0 may include port 0 and port 1, CDM port 1 may include port 2 and port 3, CDM group 2 may include port 4 and port 5, CDM group 3 may support port 6 and port 7, CDM group 4 may include port 14, port 15, port 20 and port 21 and CDM group 5 may include port 16, port 17, port 22 and port 23.

For DMRS type 2, each PRB may have the same CDM pattern. In example 740, to demonstrate the mapping of the different CDM groups to REs, the REs mapped to CDM group 0 are marked with a “0,” the RES mapped to CDM group 1 are marked with a “1,” the REs mapped to CDM group 2 are marked with a “2,” the REs mapped to CDM group 3 are marked with a “3,” the REs mapped to CDM group 4 are marked with a “4” and the REs mapped to CDM group 5 are marked with a “5.” This pattern provides an equal DMRS density per DMRS port in every PRB.

As described above, single symbol or two symbol DMRS may be configured. In addition, up to three additional DMRS locations may be configured in the time domain on different symbols. Thus, single symbol or two symbol DMRS may be configured to repeat in different symbols of the time domain. According to some aspects, the exemplary embodiments introduce time domain DMRS subsampling techniques that utilize these additional DMRS locations to increase the number of supported DMRS ports for CP-OFDM.

Both PDSCH DMRS and PUSCH DMRS may be configured with multiple DMRS positions in the time domain. To differentiate between different DMRS positions in the time domain, reference may be made to position 0 (hereinafter “pos0”), position 1 (hereinafter “pos1”), position 2 (hereinafter “pos2”) and position 3 (hereinafter “pos3”). The DMRS positions may be defined relative to a span of consecutive symbols (la) and/or a mapping type (e.g., PDSCH mapping type A, PDSCH mapping type B, PUSCH mapping type A, PUSCH mapping type B, etc.).

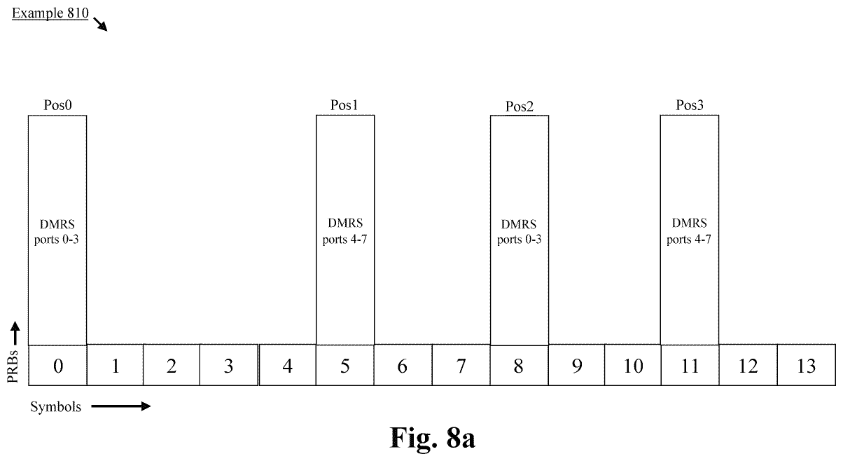

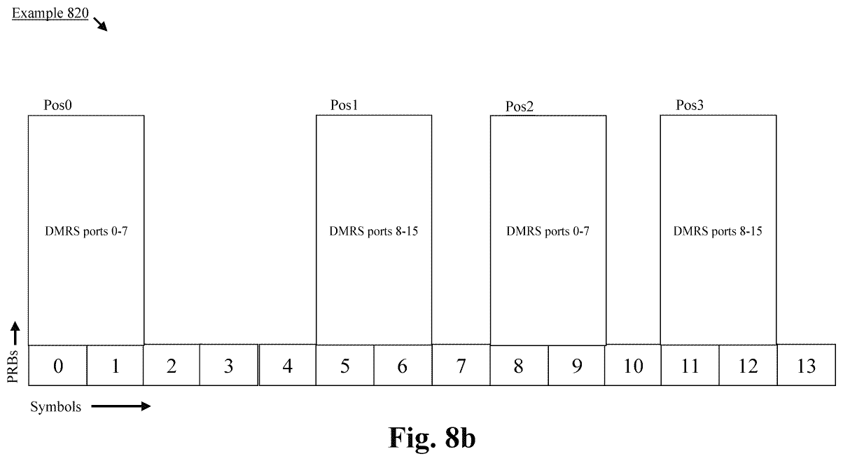

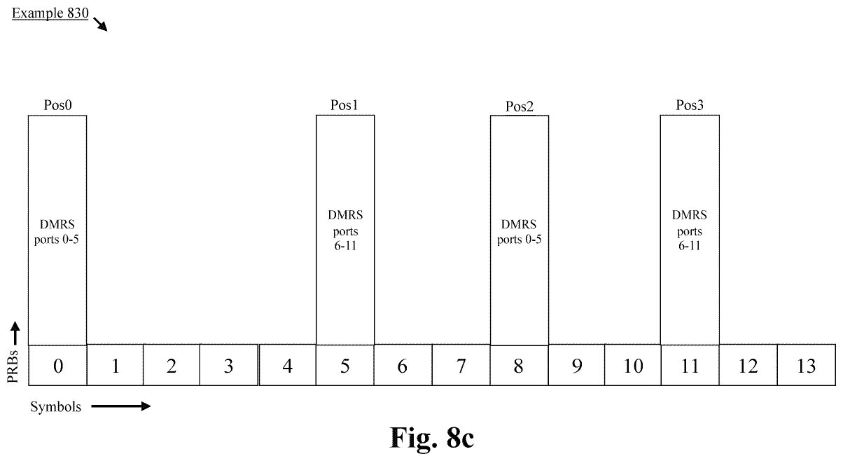

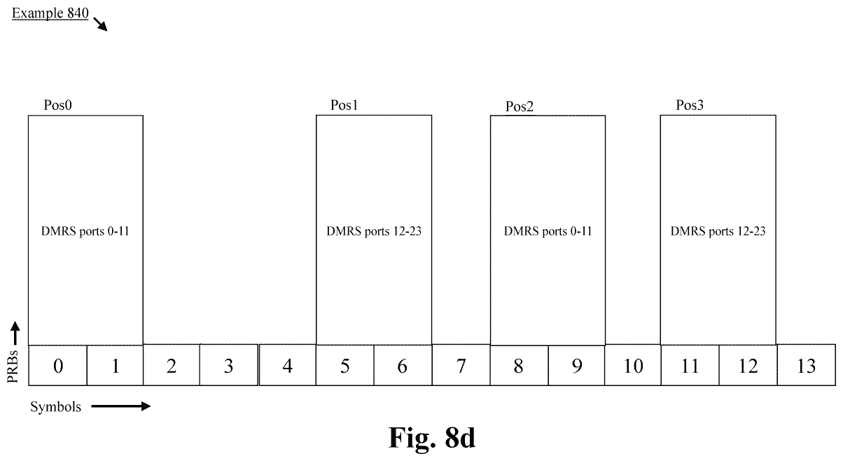

When additional DMRS locations are configured, time domain DMRS density per DMRS port may be reduced to create room for additional DMRS ports. For example, a first position in time may be used for DMRS that maps to a first set of DMRS ports and a second position in time may be used for DMRS that maps to a second different set of DMRS ports. FIGS. 8a-8d show various examples related to the time domain DMRS subsampling techniques introduced herein. These examples assume that four PDSCH DMRS positions have been configured within a span of 14 symbols indexed 0-13. The DMRS symbol location is configured as symbol 0, symbol 5, symbol 8 and symbol 11. However, the exemplary embodiments are not limited to four PDSCH DMRS positions arranged in the manner and may be utilize by any appropriate number of two or more DMRS positions in the uplink or downlink arranged in any appropriate manner.

FIG. 8a shows an example 810 of single symbol DMRS type 1 with multiple positions according to various exemplary embodiments. In example 810, DMRS pos0 is mapped to DMRS ports 0-3 (e.g., CDM groups 0-1) and DMRS pos1 is mapped to DMRS ports 4-7 (e.g., CDM groups 2-3). The pattern may repeat in the time domain and thus, DMRS pos2 is mapped to DMRS ports 0-3 (e.g., CDM groups 0-1) and DMRS pos3 is mapped to DMRS ports 4-7 (e.g., CDM groups 2-3).

FIG. 8b shows an example 820 of two symbol DMRS type 1 with multiple positions according to various exemplary embodiments. In example 820, DMRS pos0 is mapped to DMRS ports 0-7 (e.g., CDM groups 0-1) and DMRS pos1 is mapped to DMRS ports 8-15 (e.g., CDM groups 2-3). The pattern may repeat in the time domain and thus, DMRS pos2 is mapped to DMRS ports 0-7 (e.g., CDM groups 0-1) and DMRS pos3 is mapped to DMRS ports 8-15 (e.g., CDM groups 2-3).

FIG. 8c shows an example 830 of single symbol DMRS type 2 with multiple positions according to various exemplary embodiments. In example 830, DMRS pos0 is mapped to DMRS ports 0-5 (e.g., CDM groups 0-2) and DMRS pos1 is mapped to DMRS ports 6-11 (e.g., CDM groups 3-5). The pattern may repeat in the time domain and thus, DMRS pos2 is mapped to DMRS ports 0-5 (e.g., CDM groups 0-2) and DMRS pos3 is mapped to DMRS ports 6-11 (e.g., CDM groups 3-5).

FIG. 8d shows an example 840 of two symbol DMRS type 2 with multiple positions according to various exemplary embodiments. In example 840, DMRS pos0 is mapped to DMRS ports 0-11 (e.g., CDM groups 0-2) and DMRS pos1 is mapped to DMRS ports 12-23 (e.g., CDM groups 3-5). The pattern may repeat in the time domain and thus, DMRS pos2 is mapped to DMRS ports 0-11 (e.g., CDM groups 0-2) and DMRS pos3 is mapped to DMRS ports 12-23 (e.g., CDM groups 3-5).

As will be described in more detail below, additional DMRS locations may be configured by the network using a “dmrs-additionalPosition” parameter. In some embodiments, when additional DMRS locations are configured by the dmrs-additionalPosition parameter and time domain DMRS density is reduced to enable support of additional DMRS ports, the UE 110 PDSCH processing time may be further relaxed. The UE 110 PDSCH processing time may refer to the minimum time required between the end of the PDSCH reception and the beginning of the HARQ-ACK transmission. The processing time relaxation may be a function of the SCS of the PDSCH and/or PUCCH that is to carry the HARQ-ACK.

In some embodiments, the relaxation may be hard encoded in 3GPP specifications. When the PDSCH processing timeline relaxation is hard encoded in a 3GPP Specification (e.g., TS 38.214, etc.), additional symbols may be introduced to the timeline between the PDSCH reception and the corresponding uplink HARQ-ACK transmission. The SCS of the symbol may be determined based on the SCS of the PDSCH and/or PUCCH that is to carry the HARQ-ACK. In one example, the smallest SCS of the PDSCH and PUCCH is utilized. However, this determination may be made based on any appropriate one or more factors.

In other embodiments, the relaxation may be based on UE capability reporting. The UE 110 may transmit capability information to the network in an RRC message. The capability information may include a required or preferred timeline relaxation in units of symbols for the timeline between the PDSCH reception and the corresponding uplink HARQ-ACK transmission. The SCS of the symbol may be determine based on the SCS of the PDCSCH or the PUCCH that is to carry the HARQ-ACK. In one example, the smallest SCS of the PDSCH and PUCCH is utilized. However, this determination may be made based on any appropriate one or more factors.

Those skilled in the art will understand that for CP-OFDM there is a correlation between transmission layers and DMRS ports and thus, increasing the number of supported DMRS ports may allow CP-OFDM to support more transmission layers. Compared to conventional approaches, the exemplary techniques introduced above may allow CP-OFDM to support more DRMS ports without increasing the DMRS overhead. In addition, the exemplary embodiments introduce signaling mechanisms to implement the exemplary frequency domain DMRS subsampling techniques and/or time domain DMRS subsampling techniques described herein.

When the network schedules PDSCH or PUSCH, the network may also indicate which DMRS ports are assigned to the UE 110. Typically, the UE 110 may not be expected to support more than eight layers. However, in some deployment scenarios such as, but not limited to, MU-MIMO, it may be beneficial for CP-OFDM to utilize more than eight layers. Accordingly, there may be scenarios where the network allocates resources to multiple DMRS ports but the UE 110 is only configured to utilize a subset of those DMRS ports and the other DMRS ports may be available for other UEs.

In the examples described above, regardless of whether a frequency domain density reduction approach or a time domain density reduction approach is used to increase the maximum number of DMRS ports supported for CP-OFDM, DMRS type 1 may support up to four CDM groups (e.g., CDM groups 0-3) and DMRS type 2 may support up to six CDM groups (e.g., CDM groups 0-5). Each CDM group may support a maximum of two DMRS ports for single symbol DMRS and a maximum of four ports for two symbol DMRS. Therefore, single symbol DMRS type 1 may support up to eight DMRS ports and two symbol DMRS type 1 may support up to 16 DMRS ports. In addition, single symbol DMRS type 2 may support up to twelve DMRS ports and two symbol DMRS type 2 may support up to 24 DMRS ports.

DMRS port configuration and indication are complex tasks and thus, it may be beneficial to utilize aspects of existing mechanisms for DMRS port indication. For example, 3GPP specifications such as technical specification (TS) 38.212 include various antenna port indication tables for both downlink and uplink communications, e.g., 38.212 Tables 7.3.1.1.2-Aug. 9, 2010/11/12/13/14/15/16/17/18/19/20/21/22/23 for uplink DCI format 0_1/0_2 and Tables 7.3.1.2.2-1/2/3/4/1A/2A/3A/4A for downlink DCI format 1_1/1_2. From a signaling aspect, the network may indicate a codeword to the UE 110 that corresponds to one of the above referenced tables. The codeword may be a value (e.g., 0-M) and each value may correspond to one or more parameter values. For example, a codeword value may be associated with a parameter indicating a number of DMRS CDM groups without data and a parameter indicating which DMRS ports are to be utilized. As will be described in more detail below, the exemplary signaling mechanisms introduced herein allow these existing aspects of DMRS port indication to be utilized even when a frequency domain density reduction approach or a time domain density reduction approach is used to increase the maximum number of DMRS ports supported for CP-OFDM.

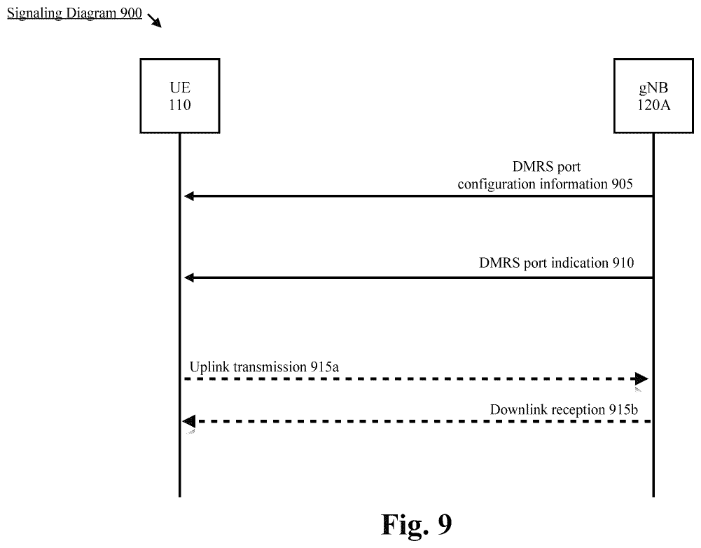

FIG. 9 shows a signaling diagram 900 for providing the UE 110 with a DMRS port indication for CP-OFDM according to various exemplary embodiments. The signaling diagram 900 includes the UE 110 and the gNB 120A.

In 905, the UE 110 receives DMRS port configuration information. The DMRS configuration information may be received in a radio resource control (RRC) message, a medium access control (MAC) control element (CE), downlink control information (DCI) or any other appropriate type of information. The DMRS port configuration information may include information such as, but not limited to, a maximum number of supported DMRS ports, a maximum number of supported CDM groups, whether frequency domain frequency reduction techniques are to be utilized and whether time domain frequency reduction techniques are to be utilized.

In 910, the UE 110 receives a DMRS port indication from the gNB 120A. When the network schedules PDSCH or PUSCH, the network may indicate which DMRS ports are assigned to the UE 110. The DMRS port indication may indicate which DMRS ports to be used for DMRS transmission. In addition, the DMRS port indication may facilitate MU-MIMO operations and/or DMRS power boosting.

As mentioned above, the DMRS port indication may include a codeword value. The UE 110 may be preconfigured with one or more tables that indicate one or more DMRS ports assigned to the UE 110 based on the codeword value. In some embodiments, the DMRS port indication may be received as part of DCI scheduling PDSCH or PUSCH. However, reference to scheduling DCI is merely provided for illustrative purposes, the DMRS port indication may be provided in any appropriate message.

In addition, the network may indicate whether the UE 110 is to use one or more CDM groups from a first set of CDM groups or one or more CDM groups from a second different set of CDM groups. The first set of CDM groups may comprise the legacy CDM groups and the second set of CDM groups may comprise the additional DMRS ports enabled by the exemplary embodiments introduced herein. To provide some examples, for single symbol DMRS type 1 and two symbol DMRS type 1, the first set of CDM groups may include CDM groups 0-1 and the second set of CDM groups may include CDM groups 2-3. For single symbol DMRS type 2 and two symbol DMRS type 2, the first set of CDM groups may include CDM groups 0-2 and the second set of CDM groups may include CDM groups 3-5.

A single bit in the scheduling DCI may be used to indicate whether the UE 110 is to utilize one or more CDM groups from the first set of CDM groups or the second set of CDM groups. Throughout this description, this bit may be referred to as the “additional DMRS bit”. To provide an example, when the additional DMRS bit is set to a first value, this may indicate to the UE 110 that the DMRS ports indicated by the codeword are to be utilized, e.g., the legacy CDM groups. When the additional DMRS bit is set to a second value, this may indicate to the UE 110 that the additional CDM groups introduced herein are to be utilized. For DMRS type 1, when the codeword value indicates that DMRS ports included in CDM group 0 are to be utilized and the additional DMRS bit is set to the second value, this may implicitly indicate to the UE 110 that DMRS ports included in CDM group 2 are to be utilized instead of the DMRS ports indicated by the codeword. For DMRS type 1, when the codeword value indicates the one or more DMRS ports included in CDM group 1 are to be utilized and the additional DMRS bit is set to the second value, this may implicitly indicate to the UE 110 that one or more DMRS ports from CDM group 3 are to be utilized instead of the DMRS ports indicated by the codeword. These exemplary embodiments allow for existing DMRS port indication mechanisms to be utilized for the additional DMRS ports by only adding a single bit to the signaling overhead.

To provide some more examples, for DMRS type 2, when the codeword value indicates that one or more DMRS ports included in CDM group 0 are to be utilized and the additional DMRS bit is set to the second value, this may implicitly indicate to the UE 110 that one or more DMRS ports included in CDM group 3 are to be utilized instead of the DMRS ports indicated by the codeword. For DMRS type 2, when the codeword value indicates the one or more DMRS ports included in CDM group 1 are to be utilized and the additional DMRS bit is set to the second value, this may implicitly indicate to the UE 110 that one or more DMRS ports included in CDM group 4 are to be utilized instead of the DMRS ports indicated by the codeword. For DMRS type 2, when the codeword value indicates that one or more DMRS ports included in CDM group 2 are to be utilized and the additional DMRS bit is set to the second value, this may implicitly indicate to the UE 110 that one or more DMRS ports included in CDM group 5 are to be utilized instead of the DMRS indicated by the codeword. Like the examples provided above, these exemplary embodiments may allow for existing DMRS port indication mechanisms to be utilized for the additional DMRS ports by only adding a single bit to the signaling overhead.

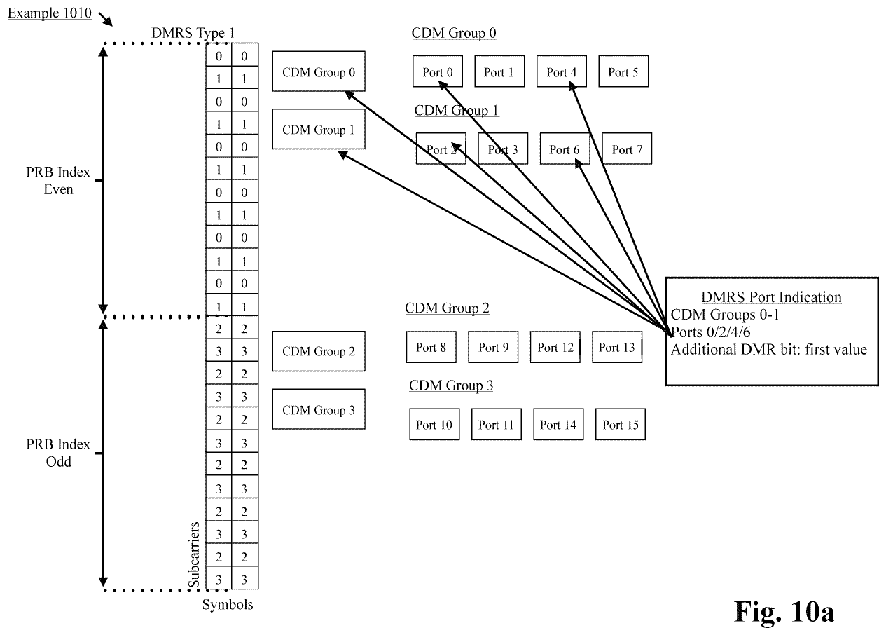

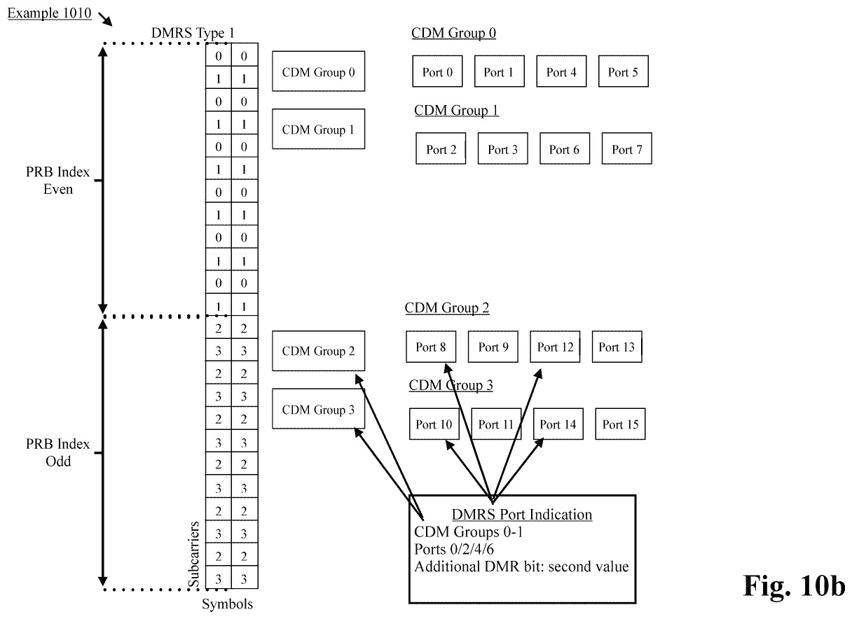

FIGS. 10a-10b show examples of different DMRS port configurations according to various exemplary embodiments. FIG. 10a shows an example 1010 of a DMRS port configuration when the additional DMRS bit is set to a first value (e.g., 1 or 0). In example 1010, the DMRS is two symbol DMRS type 1 where even indexed PRBs are mapped to CDM groups 0-1 and odd indexed PRBs are mapped to CDM groups 2-3. CDM group 0 includes port 0, port 1, port 4 and port 5, CDM group 1 includes port 2, port 3, port 6 and port 7, CDM group 2 includes port 8, port 9, port 12 and port 13 and CDM group 3 includes port 10, port 11, port 14 and port 15.

In example 1010, the additional DMRS bit it set to the first value. This may indicate to the UE 110 that a first set of CDM groups, e.g., legacy CDM groups are to be utilized. Here, it is assumed that the codeword value indicates that CDM groups 0-1 are without data and DMRS ports used for scheduling the UE 110 include port 0, port 2, port 4, port 6.

FIG. 10b shows an example 1020 of a DMRS port configuration when the additional DMRS bit is set to a second value. Like example 1010, in example 1020, the DMRS is two symbol DMRS type 1 where even indexed PRBs are mapped to CDM groups 0-1 and odd indexed PRBs are mapped to CDM groups 2-3. CDM group 0 includes port 0, port 1, port 4 and port 5, CDM group 1 includes port 2, port 3, port 6 and port 7, CDM group 2 includes port 8, port 9, port 12 and port 13 and CDM group 3 includes port 10, port 11, port 14 and port 15.

In example 1020, the additional DMRS bit it set to the second value. This may indicate to the UE 110 that a second different set of CDM groups (e.g., the additional CDM groups introduced herein) are to be utilized instead of the CDM groups indicated by the codeword. The arrows show that the DMRS ports that are to be used by the UE 110 are not the same DMRS ports indicated by the codeword. Like in example 1010, the codeword value indicates that CDM groups 0-1 are without data and DMRS ports used for scheduling the UE 110 include port 0, port 2, port 4, port 6. However, the additional DMRS bit implicitly indicates to the UE 110 that DMRS ports included in CDM group 2 and 3 are to be utilized. Thus, in this example, the DMRS indication implicitly indicates that DMRS port 8, port 10, port 12 and port 14 are to be utilized by the scheduled UE 110.

The DMRS ports may be applicable to the uplink and/or downlink. Thus, in 915a, if the scheduling DCI is for PUSCH or any other appropriate type of uplink communication, the UE 110 may perform an uplink transmission using the indicated DMRS ports. Alternatively, in 915b, if the scheduling DCI is for PDSCH or any other appropriate type of downlink communication, the UE 110 may perform a downlink reception using the indicated DMRS ports.

### EXAMPLES

In a first example, a processor of a user equipment (UE) is configured to establish a connection to a fifth generation (5G) new radio (NR) network, wherein the connection is configured to utilize cyclic prefix (CP)-orthogonal frequency division multiplexing (OFDM) waveform and demodulation reference signal (DMRS) type 1, receive a DMRS port indication configured to indicate one or more DMRS ports assigned to the UE, wherein single symbol DMRS type 1 is configured to support up to eight DMRS ports and two symbol DMRS type 1 is configured to support up to sixteen DMRS ports and perform a transmission operation or a reception operation using the one or more DMRS ports assigned to the UE.

In a second example, the processor of the first example, further configured to receive a message indicating that the DMRS type 1 is configured with multiple positions in the time domain within a span of a number of consecutive symbols.

In a third example, the processor of the second example, wherein a first position of the multiple positions is configured to support a first set of DMRS ports and a second position of the multiple positions is configured to support a second different set of DMRS ports.

In a fourth example, the processor of the first example, further configured to receive an indication of whether the DMRS port indication maps to a first set of DMRS ports or a second different set of DMRS ports.

In a fifth example, the processor of the fourth example, wherein the indication is a single bit.

In a sixth example, the processor of the fifth example, wherein when the single bit is set to a first value, the DMRS port indication maps to the first set of DMRS ports comprising legacy DMRS ports.

In a seventh example, the processor of the sixth example, wherein the DMRS port indications comprise a codeword value, when the single bit is set to a second value, the DMRS port indication maps to the second set of DMRS ports and wherein the second set of DMRS ports are not explicitly indicated by the codeword value.

In an eighth example, a user equipment comprises a transceiver configured to communicate with a fifth generation (5G) new radio (NR) network and a processor communicatively coupled to the transceiver and configured to establish a connection to the network, wherein the connection is configured to utilize cyclic prefix (CP)-orthogonal frequency division multiplexing (OFDM) waveform and demodulation reference signal (DMRS) type 1, receive a DMRS port indication configured to indicate one or more DMRS ports assigned to the UE, wherein single symbol DMRS type 1 is configured to support up to eight DMRS ports and two symbol DMRS type 1 is configured to support up to sixteen DMRS ports and perform a transmission operation or a reception operation using the one or more DMRS ports assigned to the UE.

In a ninth example, a processor of a base station is configured to establish a connection to a user equipment (UE), wherein the connection is configured to utilize cyclic prefix (CP)-orthogonal frequency division multiplexing (OFDM) waveform and demodulation reference signal (DMRS) type 1, transmit a DMRS port indication configured to indicate one or more DMRS ports assigned to the UE, wherein single symbol DMRS type 1 is configured to support up to eight DMRS ports and two symbol DMRS type 1 is configured to support up to sixteen DMRS ports and perform a transmission operation or a reception operation.

In a tenth example, the processor of the ninth example, further configured to transmit a message indicating that the DMRS type 1 is configured with multiple positions in the time domain within a span of a number of consecutive symbols.

In an eleventh example, the processor of the tenth example, wherein a first position of the multiple positions is configured to support a first set of DMRS ports and a second position of the multiple positions is configured to support a second different set of DMRS ports.

In a twelfth example, the processor of the ninth example, further configured to transmit an indication of whether the DMRS port indication maps to a first set of DMRS ports or a second different set of DMRS ports.

In a thirteenth example, the processor of the twelfth example wherein the indication is a single bit.

In a fourteenth example, the processor of the thirteenth example, wherein when the single bit is set to a first value, the DMRS port indication maps to the first set of DMRS ports comprising legacy DMRS ports.

In a fifteenth example, the processor of the thirteenth example, wherein the DMRS port indication comprises a codeword value, when the single bit is set to a second value, the DMRS port indication maps to the second set of DMRS ports and wherein the second set of DMRS ports are not explicitly indicated by the codeword value.

In a sixteenth example, a base station comprises a transceiver configured to communicate with a user equipment (UE) and a processor communicatively coupled to the transceiver and configured to establish a connection to the UE, wherein the connection is configured to utilize cyclic prefix (CP)-orthogonal frequency division multiplexing (OFDM) waveform and demodulation reference signal (DMRS) type 1, transmit a DMRS port indication configured to indicate one or more DMRS ports assigned to the UE, wherein single symbol DMRS type 1 is configured to support up to eight DMRS ports and two symbol DMRS type 1 is configured to support up to sixteen DMRS ports and perform a transmission operation or a reception operation.

In a seventeenth example, a processor of a user equipment (UE) is configured to establish a connection to a fifth generation (5G) new radio (NR) network, wherein the connection is configured to utilize cyclic prefix (CP)-orthogonal frequency division multiplexing (OFDM) waveform and demodulation reference signal (DMRS) type 2, receive a DMRS port indication configured to indicate one or more DMRS ports assigned to the UE, wherein single symbol DMRS type 2 is configured to support up to twelve DMRS ports and two symbol DMRS type 2 is configured to support up to twenty four DMRS ports and perform a transmission operation or a reception operation using the one or more DMRS ports assigned to the UE.

In an eighteenth example, the processor of the seventeenth example, further configured to receive an indication of whether the DMRS port indication maps to a first set of DMRS ports or a second different set of DMRS ports.

In a nineteenth example, the processor of the eighteenth example, wherein the indication is a single bit.

In a twentieth example, the processor of the nineteenth example, wherein when the single bit is set to a first value, the DMRS port indication maps to the first set of DMRS ports comprising legacy DMRS ports.

In a twenty first example, the processor of the twentieth example, wherein the DMRS port indications comprises a codeword value, when the single bit is set to a second value, the DMRS port indication maps to the second set of DMRS ports and wherein the second set of DMRS ports are not explicitly indicated by the codeword value.

In a twenty second example, a user equipment comprises a transceiver configured to communicate with a fifth generation (5G) new radio (NR) network and a processor communicatively coupled to the transceiver and configured to establish a connection to the network, wherein the connection is configured to utilize cyclic prefix (CP)-orthogonal frequency division multiplexing (OFDM) waveform and demodulation reference signal (DMRS) type 2, receive a DMRS port indication configured to indicate one or more DMRS ports assigned to the UE, wherein single symbol DMRS type 2 is configured to support up to twelve DMRS ports and two symbol DMRS type 2 is configured to support up to twenty four DMRS ports and perform a transmission operation or a reception operation using the one or more DMRS ports assigned to the UE,
In a twenty third example, a processor of a base station is configured to establish a connection to a user equipment (UE), wherein the connection is configured to utilize cyclic prefix (CP)-orthogonal frequency division multiplexing (OFDM) waveform and demodulation reference signal (DMRS) type 2, transmit a DMRS port indication configured to indicate one or more DMRS ports assigned to the UE, wherein single symbol DMRS type 2 is configured to support up to twelve DMRS ports and two symbol DMRS type 2 is configured to support up to twenty four DMRS ports and perform a transmission operation or a reception operation using the one or more DMRS ports assigned to the UE.

In a twenty fourth example, the processor of the twenty third example, further configured to transmit a message indicating that the DMRS type 2 is configured with multiple positions in the time domain within a span of a number of consecutive symbols.

In a twenty fifth example, the processor of the twenty fourth example, wherein a first position of the multiple positions is configured to support a first set of DMRS ports and a second position of the multiple positions is configured to support a second different set of DMRS ports.

In a twenty sixth example, the processor of the twenty third example, further configured to transmit an indication of whether the DMRS port indication maps to a first set of DMRS ports or a second different set of DMRS ports.

In a twenty seventh example, the processor of the twenty sixth example, wherein the indication is a single bit.

In a twenty eighth example, the processor of the twenty seventh example, wherein when the single bit is set to a first value the DMRS port indication maps to the first set of DMRS ports comprising legacy DMRS ports.

In a twenty ninth example, the processor of the twenty eighth example, wherein the DMRS port indications comprises a codeword value, when the single bit is set to a second value, the DMRS port indication maps to the second set of DMRS ports and wherein the second set of DMRS ports are not explicitly indicated by the codeword value.

In a thirtieth example, a base station comprises a transceiver configured to communicate with a user equipment (UE) and a processor communicatively coupled to the transceiver and configured to establish a connection to the UE, wherein the connection is configured to utilize cyclic prefix (CP)-orthogonal frequency division multiplexing (OFDM) waveform and demodulation reference signal (DMRS) type 2, transmit a DMRS port indication configured to indicate one or more DMRS ports assigned to the UE, wherein single symbol DMRS type 2 is configured to support up to twelve DMRS ports and two symbol DMRS type 2 is configured to support up to twenty four DMRS ports and perform a transmission operation or a reception operation using the one or more DMRS ports assigned to the UE.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as ios, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to:
establish a connection to a fifth generation (5G) new radio (NR) network, wherein the connection is configured to utilize cyclic prefix (CP)-orthogonal frequency division multiplexing (OFDM) waveform and demodulation reference signal (DMRS) type 1;
receive a DMRS port indication configured to indicate one or more DMRS ports assigned to the UE, wherein single symbol DMRS type 1 is configured to support up to eight DMRS ports and two symbol DMRS type 1 is configured to support up to sixteen DMRS ports; and
perform a transmission operation or a reception operation using the one or more DMRS ports assigned to the UE.

2. The processor of claim 1, wherein DMRS type 1 is configured to support up to four code division multiplexing (CDM) groups.

3. The processor of claim 2, wherein even indexed physical resource blocks (PRBs) of DMRS type 1 are configured to support two CDM groups from the four CDM groups and odd indexed PRBs are configured to supported two different CDM groups from the four CDM groups.

4. The processor of claim 2, wherein each physical resource block (PRB) of DMRS type 1 is configured to support the four CDM groups.

5. The processor of claim 4, wherein even indexed PRBs are configured with a first CDM pattern and odd indexed PRBs are configured with a second CDM pattern.

6. A processor of a base station configured to:
establish a connection to a user equipment (UE), wherein the connection is configured to utilize cyclic prefix (CP)-orthogonal frequency division multiplexing (OFDM) waveform and demodulation reference signal (DMRS) type 1;
transmit a DMRS port indication configured to indicate one or more DMRS ports assigned to the UE, wherein single symbol DMRS type 1 is configured to support up to eight DMRS ports and two symbol DMRS type 1 is configured to support up to sixteen DMRS ports; and
perform a transmission operation or a reception operation using the one or more DMRS ports assigned to the UE.

7. The processor of claim 6, wherein DMRS type 1 is configured to support up to four code division multiplexing (CDM) groups.

8. The processor of claim 7, wherein even indexed physical resource blocks (PRBs) of DMRS type 1 are configured to support two CDM groups from the four CDM groups and odd indexed PRBs are configured to supported two different CDM groups from the four CDM groups.

9. The processor of claim 7, wherein each physical resource block (PRB) of DMRS type 1 is configured to support the four CDM groups.

10. The processor of claim 9, wherein even indexed PRBs are configured with a first CDM pattern and odd indexed PRBs are configured with a second different CDM pattern.

11. A processor of a user equipment (UE) configured to:
establish a connection to a fifth generation (5G) new radio (NR) network, wherein the connection is configured to utilize cyclic prefix (CP)-orthogonal frequency division multiplexing (OFDM) waveform and demodulation reference signal (DMRS) type 2;
receive a DMRS port indication configured to indicate one or more DMRS ports assigned to the UE, wherein single symbol DMRS type 2 is configured to support up to twelve DMRS ports and two symbol DMRS type 2 is configured to support up to twenty four DMRS ports; and
perform a transmission operation or a reception operation using the one or more DMRS ports assigned to the UE.

12. The processor of claim 11, wherein DMRS type 2 is configured to support up to six code division multiplexing (CDM) groups.

13. The processor of claim 12, wherein even indexed physical resource blocks (PRBs) of DMRS type 2 are configured to support three CDM groups from the six CDM groups and odd indexed PRBs are configured to supported three different CDM groups from the six CDM groups.

14. The processor of claim 12, wherein each physical resource block (PRB) of DMRS type 2 is configured to support the six CDM groups.

15. The processor of claim 11, further configured to:
receive a message indicating that the DMRS type 2 is configured with multiple positions in the time domain within a span of a number of consecutive symbols.

16. The processor of claim 15, wherein a first position of the multiple positions is configured to support a first set of DMRS ports and a second position of the multiple positions is configured to support a second different set of DMRS ports.

17-20. (canceled)
